(19) United States
(12) Patent Application Publication
(10) Pub. No.: US 2007/0171573 A1
(43) Pub. Date: Jul. 26, 2007

(54) Magnetic recording medium

(75) Inventors: Masahito Oyanagi, Kanagawa (JP); Takeshi Harasawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/487,473

(22) Filed: Jul. 17, 2006

(30) Foreign Application Priority Data
Jul. 19, 2005 (JP) 2005-208537

(51) Int. Cl. G11B 5/706

(52) U.S. Cl. 360/131; 428/844

(57) ABSTRACT

Provided is a magnetic recording medium affording both reduced head abrasion and good durability in high-density magnetic recording and reproduction systems employing MR heads as reproduction heads. The magnetic recording medium comprises a nonmagnetic layer comprising a nonmagnetic powder and a binder and a magnetic layer comprising a ferromagnetic powder, a binder and an abrasive in this order on a nonmagnetic support. The abrasive comprises carbide having a mean particle diameter ranging from 0.02 to 0.10 micrometer.

### CROSS-REFERENCE TO RELATED APPLICATIONS

This application claims benefit of priority under 35 USC 119 to Japanese Patent Application No. 2005-208537 filed on Jul. 19, 2005.

### BACKGROUND OF THE INVENTION

1. Field of the Invention

The present invention relates to a magnetic recording medium having an excellent running durability.

2. Discussion of the Background

Magnetic recording media are employed in a wide range of applications in business use and consumer use, such as in recording information and in back-up data storage. As broadband networks and digital broadcasts have become more widespread in recent years, the quantity of data being handled has increased sharply. There is thus a strong demand for high-capacity data storage devices, and the necessity of high-density recording is increasing.

Reproduction heads based on a magnetoresistive (MR) operating principle have been proposed in recent years as being suited to high densification, and their use in hard disks and the like has begun. For example, Japanese Unexamined Patent Publication (KOKAI) Nos. 2003-22515 and 2003-272124 disclose magnetic recording media for use in high-density recording and reproduction systems employing magnetoresistive heads (MR heads) as reproduction heads. MR heads provide several times the reproduction output of conventional inductive magnetic heads. Since they do not employ induction coils, mechanical noise such as impedance noise is greatly reduced. By reducing the noise of the magnetic recording medium, it is possible to achieve a high S/N ratio and substantially improve high-density recording characteristics.

MR heads are required for high-density recording. However, since hard materials such as AlTiC (alumina titanium carbide) are employed in the head substrate, uneven abrasion (irregular abrasion) occurs in which just MR elements, shield layers, and insulating layers between head substrates are selectively abraded, tending to compromise output in high-density recording regions. Further, since MR elements are thin films, the MR element itself ends up being worn away when there is substantial overall head abrasion.

Additionally, when the quantity of the abrasive in the magnetic layer is greatly reduced or an excessively soft abrasive is employed to prevent head abrasion, the surface area of actual contact between the head and the tape while the tape is sliding against the head increases, heightening sliding resistance. Alternatively, when the hardness of the tape surface is made excessively soft relative to the head, there are problems in that the tape is damaged and durability deteriorates. Thus, there is a need for a magnetic recording medium that does not cause irregular head abrasion or overall head abrasion while retaining good durability.

### SUMMARY OF THE INVENTION

In light of these problems, it is an object of the present invention to provide a magnetic recording medium affording both reduced head abrasion and good durability in high-density magnetic recording and reproduction systems employing MR heads as reproduction heads.

The present invention relates to a magnetic recording medium comprising a nonmagnetic layer comprising a nonmagnetic powder and a binder and a magnetic layer comprising a ferromagnetic powder, a binder and an abrasive in this order on a nonmagnetic support, wherein

said abrasive comprises carbide having a mean particle diameter ranging from 0.02 to 0.10 micrometer.

The present invention further relates to a method of recording a magnetic signal on the magnetic recording medium of the present invention with a recording head and reproducing the magnetic signal with a magnetoresistive head.

The present invention still further relates to an apparatus comprising a recording head, a magnetoresistive reproduction head and the magnetic recording medium of the present invention.

In the magnetic recording medium of the present invention, said magnetic layer can comprise said carbide in an amount of 0.5 to 15 weight parts per 100 parts of the ferromagnetic powder.

In the magnetic recording medium of the present invention, Sendust abrasion width Ws of said magnetic layer can range from 20 to 60 micrometers, preferably from 20 to 50 micrometers, and a ratio (Ws/Wa) of Sendust abrasion width Ws to AlTiC abrasion width Wa of said magnetic layer can be equal to or higher than 10, preferably ranges from 10 to 100, more preferably from 10 to 50.

In the magnetic recording medium of the present invention, said carbide can have a Mohs' hardness of equal to or higher than 8 but less than 10, preferably equal to or higher than 9 but less than 10.

In the magnetic recording medium of the present invention, said carbide can be at least one selected from the group consisting of TiC, SiC, Zrc, B₄C, WC and VC, preferably selected from the group consisting of TiC, SiC and B₄C.

In the magnetic recording medium of the present invention, said magnetic layer can have a thickness ranging from 0.03 to 0.10 micrometer.

In the magnetic recording medium of the present invention, said ferromagnetic layer can be a ferromagnetic metal powder having a mean major axis length ranging from 30 to 50 nm or a hexagonal ferrite powder having a mean plate diameter ranging from 10 to 40 nm.

According to the present invention, a magnetic recording medium for high-density recording can be provided, that is suited to high-density magnetic recording and reproduction systems employing MR heads as reproduction heads.

### BRIEF DESCRIPTION OF THE DRAWINGS

FIG. 1 is a drawing descriptive of the method of measuring abrasion width.

### DESCRIPTIONS OF THE EMBODIMENTS

The present invention will be described in greater detail below.

The magnetic recording medium of the present invention comprises a nonmagnetic powder and a binder and a magnetic layer comprising a ferromagnetic powder, a binder and an abrasive in this order on a nonmagnetic support. The abrasive comprises carbide having a mean particle diameter ranging from 0.02 to 0.10 micrometer.

[Abrasive]

The magnetic recording medium of the present invention comprises carbide having a mean particle diameter of 0.02 to 0.10 micrometer as an abrasive in the magnetic layer. This prevents head abrasion, particularly irregular MR head abrasion. The use of carbide having properties similar to those of the material (AlTiC or the like) constituting the MR head is thought to maintain a balance between the hardness of the magnetic layer and that of the MR head. The use of carbide is thought to achieve an effect of not abrading the head and not damaging the tape by preventing abrasion between the two by maintaining about the same degree of hardness between the head and the abrasive (carbide) contained in the magnetic layer.

The mean particle diameter of the carbide is 0.02 to 0.10 micrometer. When the mean particle diameter is less than 0.02 micrometer, although head abrasion can be inhibited, the medium is damaged and durability decreases. Conversely, when the mean particle diameter of the carbide exceeds 0.10 micrometer, head abrasion becomes marked and there is a risk of decreased output. The mean particle diameter of the carbide is preferably from 0.02 to 0.08 micrometer, more preferably from 0.02 to 0.06 micrometer.

The carbide preferably has a Mohs' hardness of equal to or higher than 8 but less than 10, with a Mohs' hardness of equal to or higher than 9 but less than 10 being more preferred. The shape may be spherical or irregular, and may be suitably selected. Specifically, one or more carbide selected from the group consisting of TiC, SiC, ZrC, B₄C, WC and VC may be employed. The smaller the specific gravity of an abrasive, the more it tends to be exposed on the surface of the magnetic layer, and the more effectively it tends to function as an abrasive. From this perspective, TiC, SiC, and B₄C are particularly desirable.

In the magnetic recording medium of the present invention, the content of carbide in the magnetic layer can be from 0.5 to 15 weight parts per 100 weight parts of the ferromagnetic powder. When the content of the carbide is within this range, head abrasion can be prevented while maintaining durability. This content is preferably 0.5 to 10 weight parts, more preferably 0.5 to 5 weight parts.

In the magnetic recording medium of the present invention, it is preferable that Sendust abrasion width Ws of the magnetic layer falls within a range of 20 to 60-micrometers and the ratio of Sendust abrasion width Ws to AlTiC abrasion width Wa (Ws/Wa) is equal to or higher than 10. This point will be described below. Sendust is a general name for an alloy comprised of 5.4 weight percent aluminum, 85.0 weight percent iron, and 9.6 weight percent silicon. AlTiC is a general name for a sintered material of aluminum oxide and titanium carbide.

The present inventors conducted extensive research into obtaining a magnetic recording medium that both reduced head abrasion and afforded good durability in a magnetic recording and reproduction system employing MR heads as reproduction heads, resulting in the following discoveries.

Conventionally, the amount of abrasion of Sendust (AlFeSil) has been employed as the index of abrasiveness of the magnetic layer (for example, see Japanese Unexamined Patent Publication (KOKAI) No. Heisei 11-86265). However, research by the present inventors revealed that although the amount of abrasion of Sendust corresponded to the amount of abrasion of metal in gap (MIG) heads, it did not correspond to the amount of abrasion of MR heads. Accordingly, the present inventors conducted an extensive examination of the relation between the abrasiveness of the magnetic layer relative to various materials and irregular abrasion of MR heads. As a result, they discovered that the amount of abrasion of AlTiC (alumina titanium carbide) corresponded to the amount of irregular abrasion of MR heads. On that basis, the present inventors conducted further research, resulting in the discovery that by controlling the abrasiveness of the magnetic layer so that Sendust abrasion width Ws was 20 to 60 micrometers and the ratio (Ws/Wa) of Sendust abrasion width Ws to the AlTiC abrasion width Wa was equal to or higher than 10, it was possible to both control head abrasion, particularly irregular MR head abrasion, and achieve good durability. In the present invention, it is possible to achieve a magnetic layer abrasiveness falling within the above-stated range by employing carbide having a mean particle diameter of 0.02 to 0.10 micrometer as the abrasive in the magnetic layer as set forth above.

In the present invention, the Sendust abrasion width Ws and the AlTiC abrasion width Wa are values measured by the following methods.

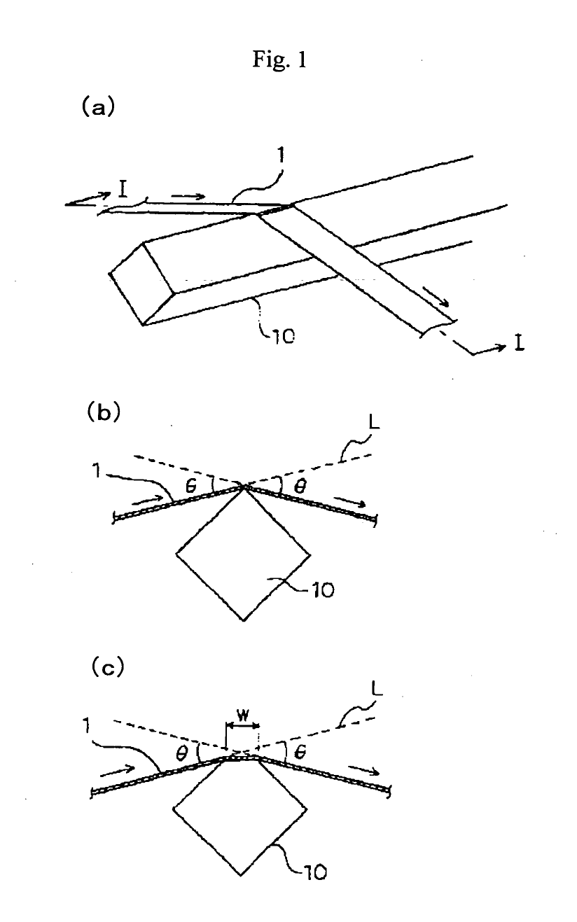

As shown in FIG. 1, square member 10 of square cross section measuring 0.5 cm on a side and, for example, having a length of 2 cm is employed. With the longitudinal direction of magnetic recording medium 1 perpendicular to the longitudinal direction of square member 10 and the surface of the magnetic layer in contact with the edge of square member 10 at a lap angle of 12°, a 200 m length of the medium is run back and forth 50 times in an environment of 23° C. at 50 percent RH with 100 g of tension on the medium at a speed of 3 m/s. When the tape is run back and forth over the edge of the square bar as set forth above, it is abraded and the edge develops a width W. The abrasion width is this width. As shown in FIGS. 1(b) and (c), the lap angle is the angle formed by the extension line L in the running direction of the magnetic recording medium on the upstream side relative to the area of contact with square member 10 with the magnetic recording medium on the downstream side, when the angle of entry of the magnetic recording medium on the upstream side is maintained identical to the angle of exit of the magnetic recording medium on the downstream side relative to the contact portion with square member 10. In the present invention, the term “longitudinal direction of the magnetic recording medium” means the longitudinal direction of the medium when the magnetic recording medium is a tape, and the original longitudinal direction of the magnetic recording medium before punching into a disk when the magnetic recording medium is a disk.

In the magnetic recording medium of the present invention, the Sendust abrasion width Ws of the magnetic layer preferably falls within a range of 20 to 60 micrometers and the ratio (Ws/Wa) of the Sendust abrasion width Ws to the AlTiC abrasion width Wa is preferably equal to or higher than 10. By setting the abrasiveness of the magnetic layer within the above ranges, it is possible to both prevent irregular abrasion of the MR head and achieve durability. This ratio is preferably 10 to 100, more preferably 10 to 50. The Sendust abrasion width Ws of the magnetic layer preferably falls within a range of 20 to 60 micrometers, more preferably 20 to 50 micrometers. In the present invention, the type, particle diameter, hardness, and the like of the carbide added to the magnetic layer can be adjusted to keep the abrasiveness of the magnetic layer within the above-stated ranges.

In the present invention, other abrasives may be used in combination with the carbide as abrasives in the magnetic layer. Examples of other abrasives that can be used in combination are conventionally employed abrasives, such as alpha-alumina with an alpha-conversion rate of equal to or higher than 90 percent, beta-alumina, microparticulate diamond, chromium oxide, cerium oxide, alpha-iron oxide, corundum, silicon nitride, titanium oxide, silicon dioxide, and boron nitride. The particle diameter of an abrasive that is employed in combination is preferably roughly identical (0.02 to 0.10 micrometer) to that of the carbide. When employing other abrasives in combination with carbide, they can be employed in a quantity equivalent to or smaller than that of the carbide so as not to compromise the effect of the carbide serving as the abrasive exhibiting the principal effect in the present invention.

[Magnetic Layer]

In the present invention, examples of the ferromagnetic powder contained in the magnetic layer are a ferromagnetic metal powder and a hexagonal ferrite powder.

The ferromagnetic metal powder is preferably a ferromagnetic metal power comprised primarily of alpha-Fe. In addition to prescribed atoms, the following atoms can be contained in the ferromagnetic metal powder: Al, Si, Ca, Mg, Ti, Cr, Cu, Y, Sn, Sb, Ba, W, La, Ce, Pr, Nd, P, Co, Mn, Zn, Ni, Sr, B and the like. Particularly, incorporation of at least one of the following in addition to alpha-Fe is desirable: Al, Ca, Mg, Y, Ba, La, Nd, Sm, Co and Ni. Incorporation of Co is particularly preferred because saturation magnetization increases and demagnetization is improved when Co forms an alloy with Fe. The Co content preferably ranges from 1 to 40 atom percent, more preferably from 15 to 35 atom percent, further preferably from 20 to 35 atom percent with respect to Fe. The content of rare earth elements such as Y preferably ranges from 1.5 to 12 atom percent, more preferably from 3 to 10 atom percent, further preferably from 4 to 9 atom percent. The Al content preferably ranges from 1.5 to 12 atom percent, more preferably from 3 to 10 atom percent, further preferably from 4 to 9 atom percent. Al and rare earth elements including Y function as sintering preventing agents, making it possible to achieve a greater sintering prevention effect when employed in combination. These ferromagnetic metal powders may be pretreated prior to dispersion with dispersing agents, lubricants, surfactants, antistatic agents, and the like, described further below. Specific examples are described in Japanese Examined Patent Publication (KOKOKU) Showa Nos. 44-14090, 45-18372, 47-22062, 47-22513, 46-28466, 46-38755, 47-4286, 47-12422, 47-17284, 47-18509, 47-18573, 39-10307, and 46-39639; and U.S. Pat. Nos. 3,026,215, 3,031,341, 3,100,194, 3,242,005, and 3,389,014.

The ferromagnetic metal powder may contain a small quantity of hydroxide or oxide. Ferromagnetic metal powders obtained by known manufacturing methods may be employed. The following are examples of methods of manufacturing ferromagnetic metal powders: methods of reducing hydroscopic iron oxide subjected to sintering preventing treatment or iron oxide with a reducing gas such as hydrogen to obtain Fe or Fe—Co particles or the like; methods of reduction with compound organic acid salts (chiefly oxalates) and reducing gases such as hydrogen; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining powder by vaporizing a metal in a low-pressure inert gas. The ferromagnetic metal powders obtained in this manner may be subjected to any of the known slow oxidation treatments. The method of reducing hydroscopic iron oxide or iron oxide with a reducing gas such as hydrogen and forming an oxide coating on the surface thereof by adjusting a partial pressure of oxygen-containing gas and inert gas, temperature and time is preferred because of low demagnetization.

The ferromagnetic metal powder preferably has a specific surface area (S_{BET}) by BET method of 40 to 80 m²/g, more preferably 45 to 70 m²/g. When the specific surface area by BET method is 40 m²/g or more, noise drops, and at 80 m²/g or less, surface smoothness are good. The crystallite size of the ferromagnetic metal powder is preferably 80 to 180 angstroms, more preferably 100 to 170 angstroms, and further preferably, 110 to 165 angstroms. The mean major axis length of the ferromagnetic metal powder preferably ranges from 30 to 50 nm, more preferably 30 to 45 nm. When the mean major axis length is 30 nm or more, magnetization loss due to thermal fluctuation does not occur, and at 50 nm or less, deterioration of error rate due to increased noises can be avoided. The mean acicular ratio {mean of (major axis length/minor axis length)} of the ferromagnetic metal powder preferably ranges from 3 to 15, more preferably from 3 to 10. The saturation magnetization (sigmaₛ) of the ferromagnetic metal powder preferably ranges from 90 to 170 A·m²/kg, more preferably from 100 to 160 A·m²/kg, and further preferably from 110 to 160 A·m²/kg. The coercivity of the ferromagnetic metal powder preferably ranges from 1,700 to 3,500 Oe, approximately 135 to 279 kA/m, more preferably from 1,800 to 3,000 Oe, approximately 142 to 239 kA/m.

The moisture content of the ferromagnetic metal powder preferably ranges from 0.1 to 2 weight percent; the moisture content of the ferromagnetic metal powder is desirably optimized depending on the type of binder. The pH of the ferromagnetic metal powder is desirably optimized depending on the combination with the binder employed; the range is normally pH 6 to 12, preferably pH 7 to 11. The stearic acid (SA) adsorption capacity (that is a measure of surface basicity) of the ferromagnetic powder preferably ranges from 1 to 15 micromol/m², more preferably from 2 to 10 micromol/m², further preferably from 3 to 8 micromol/m². When employing a ferromagnetic metal powder of which stearic acid adsorption capacity is high, the surface of the ferromagnetic metal powder is desirably modified with organic matter strongly adsorbed to the surface to manufacture a magnetic recording medium. An inorganic ion in the form of soluble Na, Ca, Fe, Ni, Sr, NH₄, SO₄, Cl, NO₂, NO₃ or the like may be contained in the ferromagnetic metal powder. These are preferably substantially not contained, but at levels of equal to or less than 300 ppm, characteristics are seldom affected. Further, the ferromagnetic metal powder employed in the present invention desirably has few pores. The content of pores is preferably equal to or less than 20 volume percent, more preferably equal to or less than 5 volume percent. So long as the above-stated particle size and magnetic characteristics are satisfied, the particles may be acicular, rice-particle shaped, or spindle-shaped. The shape is particularly preferably acicular. The magnetic recording medium with low SFD is suited to high-density digital magnetic recording because magnetization switching is sharp and peak shifts are small. It is preferable to narrow the Hc distribution of the ferromagnetic metal powder. A low Hc distribution can be achieved, for example, by improving the goethite particle size distribution, by employing monodisperse alpha-Fe₂O₃, and by preventing sintering between particles and the like in the ferromagnetic metal powder.

Examples of hexagonal ferrite powders suitable for use in the present invention are barium ferrite, strontium ferrite, lead ferrite, calcium ferrite, and various substitution products thereof, and Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Nb, Sn, Ti, V, Cr, Cu, Y, Mo, Rh, Pd, Ag, Sn, Sb, Te, W, Re, Au, Bi, La, Ce, Pr, Nd, P, Co, Mn, Zn, Ni, B, Ge, Nb and the like. Compounds to which elements such as Co—Zn, Co—Ti, Co—Ti—Zr, Co—Ti—Zn, Ni—Ti—Zn, Nb—Zn—Co, Sn—Zn—Co, Sn—Co—Ti and Nb—Zn have been added may generally also be employed. They may comprise specific impurities depending on the starting materials and manufacturing methods employed. The mean plate diameter preferably ranges from 10 to 40 nm, more preferably 10 to 30 nm. Particularly when employing an MR head in reproduction to increase a track density, a plate diameter equal to or less than 40 nm is desirable to reduce noise. A mean plate diameter equal to or higher than 10 nm yields stable magnetization without the effects of thermal fluctuation. A mean plate diameter equal to or less than 40 nm permits low noise and is suited to the high-density magnetic recording. The mean plate thickness preferably ranges from 4 to 15 nm. Consistent production is possible when the mean plate thickness is equal to or higher than 4 nm and adequate orientation can be obtained when the mean plate thickness is equal to or less than 15 nm.

The plate ratio (plate diameter/plate thickness) of the hexagonal ferrite powder preferably ranges from 1 to 15, more preferably from 1 to 7. Low plate ratio is preferable to achieve high filling property of the magnetic layer, but some times adequate orientation is not achieved. When the plate ratio is higher than 15, noise may be increased due to stacking between particles. The specific surface area by BET method of the hexagonal ferrite powders having such particle sizes ranges from 30 to 200 m²/g, almost corresponding to an arithmetic value from the particle plate diameter and the plate thickness. Narrow distributions of particle plate diameter and thickness are normally good. Although difficult to render in number form, about 500 particles can be randomly measured in a transmission electron microscope (TEM) photograph of particles to make a comparison. This distribution is often not a normal distribution. However, when expressed as the standard deviation to the average particle size, sigma/average particle size=0.1 to 1.5. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known. According to a vitrified crystallization method, powders with increased uniformity can be obtained by conducting several thermal treatments to separate crystal nucleation and growth.

A coercivity (Hc) of the hexagonal ferrite powder of about 500 to 5,000 Oe, approximately 40 to 398 kA/m, can normally be achieved. A high coercivity (Hc) is advantageous for high-density recording, but this is limited by the capacity of the recording head. The coercivity (Hc) can be controlled by particle size (plate diameter and plate thickness), the types and quantities of elements contained, substitution sites of the element, the particle producing reaction conditions, and the like. The saturation magnetization (sigmaₛ) can be 30 to 70 A·m²/kg and it tends to decrease with decreasing particle size. Known methods of improving saturation magnetization (sigma_{S}) are lowering crystallization temperature or thermal treatment temperature, shortening thermal treatment time, increasing the amount of compound added, enhancing the level of surface treatment and the like. It is also possible to employ W-type hexagonal ferrite. When dispersing the hexagonal ferrite, the surface of the hexagonal ferrite powder can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added can range from 0.1 to 10 weight percent relative to the weight of the hexagonal ferrite powder. The pH of the hexagonal ferrite powder is also important to dispersion. A pH of about 4 to 12 is usually optimum for the dispersion medium and polymer. From the perspective of the chemical stability and storage properties of the medium, a pH of about 6 to 11 can be selected. Moisture contained in the hexagonal ferrite powder also affects dispersion. There is an optimum level for the dispersion medium and polymer, usually selected from the range of 0.1 to 2.0 weight percent.

Methods of manufacturing the hexagonal ferrite include: (1) a vitrified crystallization method consisting of mixing into a desired ferrite composition barium carbonate, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to 100° C. or greater; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. Any manufacturing method can be selected in the present invention.

Examples of types of carbon black that are suitable for use in the magnetic layer are: furnace black for rubber, thermal for rubber, black for coloring, conductive carbon and acetylene black. A specific surface area of 5 to 500 m²/g, a DBP oil absorption capacity of 10 to 400 ml/100 g, and a mean particle size of 5 to 300 nm, a pH of 2 to 10 and a moisture content of 0.1 to 10 weight percent and a tap density of 0.1 to 1 g/cc are respectively desirable. Specific examples of types of carbon black employed in the magnetic layer are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemical Corporation; CONDUCTEX SC, RAVEN 150, 50, 40, 15 and RAVEN MT-P from Columbia Carbon Co., Ltd.; and Ketjen Black EC from Lion Akzo Co., Ltd. The carbon black employed may be surface-treated with a dispersant or grafted with resin, or have a partially graphite-treated surface. The carbon black may be dispersed in advance into the binder prior to addition to the magnetic layer coating liquid. These carbon blacks may be used singly or in combination. The quantity of carbon black comprised in the magnetic layer preferably ranges from 0.1 to 30 weight percent relative to the ferromagnetic powder. In the magnetic layer, carbon black works to prevent static, reduce the coefficient of friction, impart light-blocking properties, enhance film strength, and the like; the properties vary with the type of carbon black employed. Accordingly, in order to achieve desired characteristics, it is preferred that the type and the quantity of carbon black employed in the present invention are selected based on the various characteristics stated above, such as particle size, oil absorption capacity, electrical conductivity, and pH. For example, Carbon Black Handbook compiled by the Carbon Black Association may be consulted for types of carbon black suitable for use in the present invention.

Conventionally known thermoplastic resins, thermosetting resins, reactive resins and mixtures thereof may be employed as binders used in the magnetic layer. The thermoplastic resins suitable for use have a glass transition temperature of −100 to 150° C., a number average molecular weight of 1,000 to 200,000, preferably from 10,000 to 100,000, and have a degree of polymerization of about 50 to 1,000. Examples thereof are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins. Further, examples of thermosetting resins and reactive resins are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in Handbook of Plastics published by Asakura Shoten. It is also possible to employ known electron beam-cured resins. Examples and manufacturing methods of such resins are described in Japanese Unexamined Patent Publication (KOKAI) Showa No. 62-256219. The above-listed resins may be used singly or in combination. Preferred resins are combinations of polyurethane resin and at least one member selected from the group consisting of vinyl chloride resin, vinyl chloride-vinyl acetate copolymers, vinyl chloride-vinyl acetate-vinyl alcohol copolymers, and vinyl chloride-vinyl acetate-maleic anhydride copolymers, as well as combinations of the same with polyisocyanate.

Known structures of polyurethane resin can be employed, such as polyester polyurethane, polyether polyurethane, polyether polyester polyurethane, polycarbonate polyurethane, polyester polycarbonate polyurethane, and polycaprolactone polyurethane. To obtain better dispersibility and durability in all of the binders set forth above, it is desirable to introduce by copolymerization or addition reaction one or more polar groups selected from among —COOM, —SO₃M, —OSO₃M, —P═O(OM)₂, —O—P═O(OM)₂ (where M denotes a hydrogen atom or an alkali metal base), —OH, —NR₂, —N⁺R₃ (where R denotes a hydrocarbon group), epoxy groups, —SH, and —CN. The quantity of the polar group is preferably from 10⁻¹ to 10⁻⁸ mol/g, more preferably from 10⁻² to 10⁻⁶ mol/g.

Specific examples of the binders employed in the present invention are VAGH, VYHH, VMCH, VAGF, VAGD, VROH, VYES, VYNC, VMCC, XYHL, XYSG, PKHH, PKHJ, PKHC, and PKFE from Union Carbide Corporation; MPR-TA, MPR-TA5, MPR-TAL, MPR-TSN, MPR-TMF, MPR-TS, MPR-TM, and MPR-TAO from Nisshin Kagaku Kogyo K. K.; 1000W, DX80, DX81, DX82, DX83, and 100FD from Denki Kagaku Kogyo K. K.; MR-104, MR-105, MR110, MR100, MR555, and 400X-110A from Nippon Zeon Co., Ltd.; Nippollan N2301, N2302, and N2304 from Nippon Polyurethane Co., Ltd.; Pandex T-5105, T-R3080, T-5201, Burnock D-400, D-210-80, Crisvon 6109, and 7209 from Dainippon Ink and Chemicals Incorporated.; Vylon UR8200, UR8300, UR-8700, RV530, and RV280 from Toyobo Co., Ltd.; Daipheramine 4020, 5020, 5100, 5300, 9020, 9022, and 7020 from Dainichiseika Color & Chemicals Mfg. Co., Ltd.; MX5004 from Mitsubishi Chemical Corporation; Sanprene SP-150 from Sanyo Chemical Industries, Ltd.; and Saran F310 and F210 from Asahi Chemical Industry Co., Ltd.

The binder employed in the magnetic layer is normally employed in a range of 5 to 50 weight percent, preferably from 10 to 30 weight percent with respect to the ferromagnetic powder. Vinyl chloride resin, polyurethane resin, and polyisocyanate are preferably combined within the ranges of: 5 to 30 weight percent for vinyl chloride resin, when employed; 2 to 20 weight percent for polyurethane resin, when employed; and 2 to 20 weight percent for polyisocyanate. However, when a small amount of dechlorination causes head corrosion, it is also possible to employ polyurethane alone, or employ polyurethane and isocyanate alone. In the present invention, when polyurethane is employed, a glass transition temperature of −50 to 150° C., preferably 0 to 100° C., an elongation at break of 100 to 2,000 percent, a stress at break of 0.05 to 10 kg/mm², approximately 0.49 to 98 MPa, and a yield point of 0.05 to 10 kg/mm², approximately 0.49 to 98 MPa, are desirable.

Examples of polyisocyanates suitable for use in the present invention are tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co., Ltd.; and Desmodule L, Desmodule IL, Desmodule N and Desmodule HL manufactured by Sumitomo Bayer Co., Ltd. They can be used singly or in combinations of two or more by exploiting differences in curing reactivity.

Substances having lubricating effects, antistatic effects, dispersive effects, plasticizing effects, or the like may be employed as additives in the magnetic layer. Examples of additives are: molybdenum disulfide; tungsten disulfide; graphite; boron nitride; graphite fluoride; silicone oils; silicones having a polar group; fatty acid-modified silicones; fluorine-containing silicones; fluorine-containing alcohols; fluorine-containing esters; polyolefins; polyglycols; alkylphosphoric esters and their alkali metal salts; alkylsulfuric esters and their alkali metal salts; polyphenyl ethers; phenylphosphonic acid; alpha-naphthylphosphoric acid; phenylphosphoric acid; diphenylphosphoric acid; p-ethylbenzenephosphonic acid; phenylphosphinic acid; aminoquinones; various silane coupling agents and titanium coupling agents; fluorine-containing alkylsulfuric acid esters and their alkali metal salts; monobasic fatty acids (which may contain an unsaturated bond or be branched) having 10 to 24 carbon atoms and metal salts (such as Li, Na, K, and Cu) thereof; monohydric, dihydric, trihydric, tetrahydric, pentahydric or hexahydric alcohols with 12 to 22 carbon atoms (which may contain an unsaturated bond or be branched); alkoxy alcohols with 12 to 22 carbon atoms; monofatty esters, difatty esters, or trifatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 12 carbon atoms (which may contain an unsaturated bond or be branched); fatty acid esters of monoalkyl ethers of alkylene oxide polymers; fatty acid amides with 8 to 22 carbon atoms; and aliphatic amines with 8 to 22 carbon atoms.

Specific examples of the additives in the form of fatty acids are: capric acid, caprylic acid, lauric acid, myristic acid, palmitic acid, stearic acid, behenic acid, oleic acid, elaidic acid, linolic acid, linolenic acid, and isostearic acid. Examples of esters are butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, tridecyl stearate, oleyl erucate, neopentylglycol didecanoate, and ethylene glycol dioleyl. Examples of alcohols are oleyl alcohol, stearyl alcohol, and lauryl alcohol. It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K.K.). These lubricants, antistatic agents and the like need not be 100 percent pure and may contain impurities, such as isomers, unreacted material, by-products, decomposition products, and oxides in addition to the main components. These impurities are preferably comprised equal to or less than 30 weight percent, and more preferably equal to or less than 10 weight percent. The total lubricant amount is normally 0.1 to 50 weight percent, preferably 2 to 25 weight percent with respect to the ferromagnetic powder.

[Nonmagnetic Layer]

The magnetic recording medium of the present invention has a nonmagnetic layer comprising a nonmagnetic powder and a binder between the nonmagnetic support and a magnetic layer. The nonmagnetic powder comprised in the nonmagnetic layer can be selected from inorganic compounds such as metal oxides, metal carbonates, metal sulfates, metal nitrides, metal carbides, metal sulfides and the like. Examples of inorganic compounds are alpha-alumina having an alpha-conversion rate of 90 to 100 percent, beta-alumina, gamma-alumina, silicon carbide, chromium oxide, cerium oxide, alpha-iron oxide, corundum, silicon nitride, titanium carbide, titanium dioxide, silicon dioxide, tin oxide, magnesium oxide, tungsten oxide, zirconium oxide, boron nitride, zinc oxide, calcium carbonate, calcium sulfate, barium sulfate and molybdenum disulfide; these may be employed singly or in combination. Particularly desirable are titanium dioxide, zinc oxide, iron oxide and barium sulfate. Even more preferred is titanium dioxide.

The mean particle diameter of these nonmagnetic powders preferably ranges from 0.005 to 2 micrometers, but nonmagnetic powders of differing particle size may be combined as needed, or the particle diameter distribution of a single nonmagnetic powder may be broadened to achieve the same effect. What is preferred most is a mean particle diameter in the nonmagnetic powder ranging from 0.01 to 0.2 micrometer. The pH of the nonmagnetic powder particularly preferably ranges from 6 to 9. The specific surface area of the nonmagnetic powder preferably ranges from 1 to 100 m²/g, more preferably from 5 to 50 m²/g, further preferably from 7 to 40 m²/g. The crystallite size of the nonmagnetic powder preferably ranges from 0.01 micrometer to 2 micrometers, the oil absorption capacity using dibutyl phthalate (DBP) preferably ranges from 5 to 100 ml/100 g, more preferably from 10 to 80 ml/100 g, further preferably from 20 to 60 ml/100 g. The specific gravity preferably ranges from 1 to 12, more preferably from 3 to 6. The shape of the nonmagnetic powder may be any of acicular, spherical, polyhedral, or plate-shaped.

The surface of these nonmagnetic powders is preferably treated with Al₂O₃, SiO₂, TiO₂, ZrO₂, SnO₂, Sb₂O₃ and ZnO. The surface-treating agents of preference with regard to dispersibility are Al₂O₃, SiO₂, TiO₂ and ZrO₂, and Al₂O₃, SiO₂ and ZrO₂ are further preferable. These may be used singly or in combination. Depending on the objective, a surface-treatment coating layer with a coprecipitated material may also be employed, the coating structure which comprises a first alumina coating and a second silica coating thereover or the reverse structure thereof may also be adopted. Depending on the objective, the surface-treatment coating layer may be a porous layer, with homogeneity and density being generally desirable.

Carbon black can be added to the nonmagnetic layer. Mixing carbon black achieves the known effects of lowering surface electrical resistivity Rs and yielding the desired micro Vickers hardness. Examples of types of carbon black that are suitable for use are furnace black for rubber, thermal for rubber, black for coloring and acetylene black. The specific surface area of carbon black employed preferably ranges from 100 to 500 m²/g, more preferably from 150 to 400 m²/g, and the DBP oil absorption capacity preferably ranges from 20 to 400 ml/100 g, more preferably from 30 to 200 ml/100 g. The mean particle diameter of carbon black preferably ranges from 5 to 80 nm (5 to 80 mμ), more preferably from 10 to 50 nm (10 to 50 mμ), further preferably from 10 to 40 nm (10 to 40 mμ). It is preferable for carbon black that the pH ranges from 2 to 10, the moisture content ranges from 0.1 to 10 percent and the tap density ranges from 0.1 to 1 g/ml. Specific examples of types of carbon black suitable for use are: BLACK PEARLS 2000, 1300, 1000, 900, 800, 880, 700 and VULCAN XC-72 from Cabot Corporation; #3050B, #3150B, #3250B, #3750B, #3950B, #950, #650B, #970B, #850B and MA-600 from Mitsubishi Chemical Corporation; CONDUCTEX SC, RAVEN 8800, 8000, 7000, 5750, 5250, 3500, 2100, 2000, 1800, 1500, 1255 and 1250 from Columbia Carbon Co., Ltd.; and Ketjen Black EC from Lion Akzo Co., Ltd.

As regards binders, lubricants, dispersants, additives, solvents, dispersion methods and the like of the nonmagnetic layer, known techniques regarding magnetic layers can be applied. In particular, known techniques for magnetic layers regarding types and amounts of binders, additives and dispersants can be applied to the nonmagnetic layer.

The nonmagnetic layer can be formed by coating the nonmagnetic layer coating liquid prepared by the aforementioned materials onto a nonmagnetic support.

All or some of the additives used in the present invention may be added at any stage in the process of manufacturing the magnetic and nonmagnetic coating liquids. For example, they may be mixed with the ferromagnetic powder before a kneading step; added during a step of kneading the ferromagnetic powder, the binder, and the solvent; added during a dispersing step; added after dispersing; or added immediately before coating. Part or all of the additives may be applied by simultaneous or sequential coating after the magnetic layer has been applied to achieve a specific purpose. Depending on the objective, the lubricant may be coated on the surface of the magnetic layer after calendering or making slits. Known organic solvents may be employed in the present invention. For example, the solvents described in Japanese Unexamined Patent Publication (KOKAI) Showa No. 6-68453 may be employed.

[Layer Structure]

In the magnetic recording medium of the present invention, the thickness of the nonmagnetic support preferably ranges from 2 to 100 micrometers, more preferably from 2 to 80 micrometers. For computer-use magnetic recording tapes, the nonmagnetic support having a thickness of 3.0 to 6.5 micrometers, preferably 3.0 to 6.0 micrometers, more preferably 4.0 to 5.5 micrometers is suitably employed.

An undercoating layer may be provided to improve adhesion between the nonmagnetic support and the nonmagnetic layer or magnetic layer. The thickness of the undercoating layer can be made from 0.01 to 0.5 micrometer, preferably from 0.02 to 0.5 micrometer. The magnetic recording medium of the present invention may be a disk-shaped medium in which a nonmagnetic layer and magnetic layer are provided on both sides of the nonmagnetic support, or may be a tape-shaped or disk-shaped magnetic recording medium having these layers on just one side. In the latter case, a backcoat layer may be provided on the opposite surface of the nonmagnetic support from the surface on which is provided the magnetic layer to achieve effects such as preventing static and compensating for curl. The thickness of the backcoat layer is, for example, from 0.1 to 4 micrometers, preferably from 0.3 to 2.0 micrometers. Known undercoating layers and backcoat layers may be employed.

In the magnetic recording medium of the present invention, the thickness of the magnetic layer can be optimized based on the saturation magnetization of the head employed, the length of the head gap, and the recording signal band, and is preferably 0.03 to 0.10 micrometer, more preferably 0.03 to 0.08 micrometer. The magnetic layer may be divided into two or more layers having different magnetic characteristics, and a known configuration relating to multilayered magnetic layer may be applied.

The nonmagnetic layer is normally 0.2 to 5.0 micrometers, preferably 0.3 to 3.0 micrometers, and more preferably, 1.0 to 2.5 micrometers in thickness. The nonmagnetic layer exhibits its effect so long as it is substantially nonmagnetic. For example, the effect of the present invention is exhibited even when trace quantities of magnetic material are incorporated as impurities or intentionally incorporated, and such incorporation can be viewed as substantially the same configuration as the present invention.

[Backcoat Layer]

Generally, computer data recording-use magnetic tapes are required to have far better repeat running properties than audio and video tapes. Carbon black and inorganic powders are desirably incorporated into the backcoat layer to maintain high running durability.

Two types of carbon black of differing mean particle diameter are desirably combined for use. In this case, microparticulate carbon black with a mean particle diameter of 10 to 50 nm and coarse particulate carbon black with a mean particle diameter of 70 to 300 nm are desirably combined for use. Generally, the addition of such microparticulate carbon black makes it possible to set a lower surface electrical resistance and optical transmittance in the backcoat layer. Many magnetic recording devices exploit the optical transmittance of the tape in an operating signal. In such cases, the addition of microparticulate carbon black is particularly effective. Microparticulate carbon black generally enhances liquid lubricant retentivity, contributing to a reduced coefficient of friction when employed with lubricants.

Examples of specific microparticulate carbon black products are given below and the mean particle diameter is given in parentheses: BLACK PEARLS 800 (17 nm), BLACK PEARLS 1400 (13 nm), BLACK PEARLS 1300 (13 nm), BLACK PEARLS 1100 (14 nm), BLACK PEARLS 1000 (16 nm), BLACK PEARLS 900 (15 nm), BLACK PEARLS 880 (16 nm), BLACK PEARLS 4630 (19 nm), BLACK PEARLS 460 (28 nm), BLACK PEARLS 430 (28 nm), BLACK PEARLS 280 (45 nm), MONARCH 800 (17 nm), MONARCH 14000 (13 nm), MONARCH 1300 (13 nm), MONARCH 1100 (14 nm), MONARCH 1000 (16 nm), MONARCH 900 (15 nm), MONARCH 880 (16 nm), MONARCH 630 (19 nm), MONARCH 430 (28 nm), MONARCH 280 (45 nm), REGAL 330 (25 nm), REGAL 250 (34 nm), REGAL 99 (38 nm), REGAL 400 (25 nm) and REGAL 660 (24 nm) from Cabot Corporation; RAVEN2000B (18 nm), RAVEN1500B (17 nm), Raven 7000 (11 nm), Raven 5750 (12 nm), Raven 5250 (16 nm), Raven 3500 (13 nm), Raven 2500 ULTRA (13 nm), Raven 2000 (18 nm), Raven 1500 (17 nm), Raven 1255 (21 nm), Raven 1250 (20 nm), Raven 1190 ULTRA (21 nm), Raven 1170 (211 nm), Raven 1100 ULTRA (32 nm), Raven 1080 ULTRA (28 nm), Raven 1060 ULTRA (30 nm), Raven 1040 (28 nm), Raven 880 ULTRA (30 nm), Raven 860 (39 nm), Raven 850 (34 nm), Raven 820 (32 nm), Raven 790 ULTRA (30 nm), Raven 780 ULTRA (29 nm) and Raven 760 ULTRA (30 nm) from Columbia Carbon Co., Ltd.; Asahi #90 (19 nm), Asahi #80 (22 nm), Asahi #70 (28 nm), Asahi F-200 (35 nm), Asahi #60HN (40 nm), Asahi #60 (45 nm), HS-500 (38 nm) and Asahi #51 (38 nm) from Asahi Carbon Co., Ltd.; #2700 (13 nm), #2650 (13 nm), #2400 (14 nm), #1000 (18 nm), #950 (16 nm), #850 (17 nm), #750 (22 nm), #650 (22 nm), #52 (27 nm), #50 (28 nm), #40 (24 nm), #30 (30 nm), #25 (47 nm), #95 (40 nm) and CF9 (40 nm) from Mitsubishi Chemical Corporation; PRINTEX 90 (14 nm), PRINTEX 95 (15 nm), PRINTEX 85 (16 nm), PRINTEX 75 (17 nm) from Degussa; #3950 (16 nm) from Mitsubishi Chemical Corporation.

Examples of specific coarse particulate carbon black products are given below: BLACK PEARLS 130 (75 nm), MONARCH 120 (75 nm) and Regal 99 (100 nm) from Cabot Corporation; Raven 450 (75 nm), Raven 420 (86 nm), Raven 410 (101 nm), Raven 22 (83 nm) and RAVEN MTP (275 nm) from Columbia Carbon Co., Ltd.; Asahi 50H (85 nm), Asahi #51 (91 nm), Asahi #50 (80 nm), Asahi #35 (78 nm) and Asahi #15 (122 nm) from Asahi Carbon Co., Ltd.; #10 (75 nm), #5 (76 nm) and #4010 (75 nm) from Mitsubishi Chemical Corporation; Thermal black (270 nm) from Cancarb Limited.

When employing two types of carbon black having different mean particle diameters in the backcoat layer, the ratio (by weight) of the content of microparticulate carbon black of 10 to 50 nm to that of coarse particulate carbon black of 70 to 300 nm preferably ranges from 100:0.5 to 100:100, more preferably from 100:1 to 100:50.

The content of carbon black in the backcoat layer (the total quantity when employing two types of carbon black) normally ranges from 30 to 100 weight parts, preferably 45 to 95 weight parts, per 100 weight parts of binder.

Two types of inorganic powder of differing hardness are desirably employed in combination. Specifically, a soft inorganic powder with a Mohs' hardness of 3 to 4.5 and a hard inorganic powder with a Mohs' hardness of 5 to 9 are desirably employed. The addition of a soft inorganic powder with a Mohs' hardness of 3 to 4.5 permits stabilization of the coefficient of friction during repeat running. Within the stated range, the sliding guide poles are not worn down. The mean particle diameter of the soft inorganic powder desirably ranges from 30 to 50 nm.

Examples of soft organic powders having a Mohs' hardness of 3 to 4.5 are calcium sulfate, calcium carbonate, calcium silicate, barium sulfate, magnesium carbonate, zinc carbonate, and zinc oxide. These may be employed singly or in combinations of two or more.

The content of the soft inorganic powder in the backcoat layer preferably ranges from 10 to 140 weight parts, more preferably 35 to 100 weight parts, per 100 weight parts of carbon black.

The addition of a hard inorganic powder with a Mohs' hardness of 5 to 9 increases the strength of the backcoat layer and improves running durability. When the hard inorganic powder is employed with carbon black and the above-described soft inorganic powder, deterioration due to repeat sliding is reduced and a strong backcoat layer is obtained. The addition of the hard inorganic powder imparts suitable abrasive strength and reduces adhesion of scrapings onto the tape guide poles and the like. Particularly when employed with a soft inorganic powder, sliding characteristics on guide poles with rough surface are enhanced and the coefficient of friction of the backcoat layer can be stabilized. The mean particle diameter of the hard inorganic powder preferably ranges from 80 to 250 nm, more preferably 100 to 210 nm.

Examples of hard inorganic powders having a Mohs' hardness of 5 to 9 are alpha-iron oxide, alpha-alumina, and chromium oxide (Cr₂O₃). These powders may be employed singly or in combination. Of these, alpha-iron oxide and alpha-alumina are preferred. The content of the hard inorganic powder is normally 3 to 30 weight parts, preferably 3 to 20 weight parts, per 100 weight parts of carbon black.

When employing the above-described soft inorganic powder and hard inorganic powder in combination in the backcoat layer, the soft inorganic powder and the hard inorganic powder are preferably selected so that the difference in hardness between the two is equal to or greater than 2 (more preferably equal to or greater than 2.5, further preferably equal to or greater than 3). The backcoat layer desirably comprises the above two types of inorganic powder having the above-specified mean particle sizes and difference in Mohs' hardness and the above two types of carbon black of the above-specified mean particle sizes.

The backcoat may also contain a lubricant. The lubricant may be suitably selected from among the lubricants given as examples above for use in the nonmagnetic layer and magnetic layer. The lubricant is normally added to the backcoat layer in a proportion of 1 to 5 weight parts per 100 weight parts of binder.

[Nonmagnetic Support]

Known films of the following may be employed as the nonmagnetic support in the present invention: polyethylene terephthalate, polyethylene naphthalate and other polyesters, polyolefins, cellulose triacetate, polycarbonate, polyamides, polyimides, polyamidoimides, polysulfones, aromatic polyamides, polybenzooxazoles and the like. Supports having a glass transition temperature of equal to or higher than 100° C. are preferably employed. The use of polyethylene naphthalate, aramid, or some other high-strength support is particularly desirable. As needed, layered supports such as disclosed in Japanese Unexamined Patent Publication (KOKAI) Heisei No. 3-224127 may be employed to vary the surface roughness of the magnetic surface and support surface. These supports may be subjected beforehand to corona discharge treatment, plasma treatment, adhesion enhancing treatment, heat treatment, dust removal, and the like.

The center surface average surface roughness (SRa) of the support measured with an optical interferotype surface roughness meter HD-2000 made by WYKO is preferably equal to or less than 8.0 nm, more preferably equal to or less than 4.0 nm, further preferably equal to or less than 2.0 nm. Not only does such a support desirably have a low center surface average surface roughness, but there are also desirably no large protrusions equal to or higher than 0.5 micrometer. The surface roughness shape may be freely controlled through the size and quantity of filler added to the support as needed. Examples of such fillers are oxides and carbonates of elements such as Ca, Si, and Ti, and organic fine powders such as acrylic-based one. The support desirably has a maximum height. Rₘₐₓ equal to or less than 1 micrometer, a ten-point average roughness R_{Z} equal to or less than 0.5 micrometer, a center surface peak height. R_{P} equal to or less than 0.5 micrometer, a center surface valley depth R_{V} equal to or less than 0.5 micrometer, a center-surface surface area percentage Sr of 10 percent to 90 percent, and an average wavelength lambdaₐ of 5 to 300 micrometers. To achieve desired electromagnetic characteristics and durability, the surface protrusion distribution of the support can be freely controlled with fillers. It is possible to control within a range from 0 to 2,000 protrusions of 0.01 to 1 micrometer in size per 0.1 mm².

The F-5 value of the nonmagnetic support employed in the present invention desirably ranges from 5 to 50 kg/mm², approximately 49 to 490 MPa. The thermal shrinkage rate of the support after 30 min at 100° C. is preferably equal to or less than 3 percent, more preferably equal to or less than 1.5 percent. The thermal shrinkage rate after 30 min at 80° C. is preferably equal to or less than 1 percent, more preferably equal to or less than 0.5 percent. The breaking strength of the nonmagnetic support preferably ranges from 5 to 100 kg/mm², approximately 49 to 980 MPa. The modulus of elasticity preferably ranges from 100 to 2,000 kg/mm², approximately 0.98 to 19.6 GPa. The thermal expansion coefficient preferably ranges from 10⁻⁴ to 10⁻⁸/° C., more preferably from 10⁻⁵ to 10⁻⁶/° C. The moisture expansion coefficient is preferably equal to or less than 10⁻⁴/RH percent, more preferably equal to or less than 10⁻⁵/RH percent. These thermal characteristics, dimensional characteristics, and mechanical strength characteristics are desirably nearly equal, with a difference equal to less than 10 percent, in all in-plane directions in the support.

[Manufacturing Method]

The process for manufacturing coating liquids for magnetic and nonmagnetic layers comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. When a kneader is employed, the ferromagnetic powder or nonmagnetic powder and all or part of the binder (preferably equal to or higher than 30 weight percent of the entire quantity of binder) can be kneaded in a range of 15 to 500 parts per 100 parts of the ferromagnetic powder. Details of the kneading process are described in Japanese Unexamined Patent Publication (KOKAI) Heisei Nos. 1-106338 and 1-79274. Further, glass beads may be employed to disperse the coating liquids for magnetic and nonmagnetic layers, with a dispersing medium with a high specific gravity such as zirconia beads, titania beads, and steel beads being suitable for use. The particle diameter and fill ratio of these dispersing media are optimized for use. A known dispersing device may be employed. In the present invention, the aforementioned carbide can be dispersed uniformly with components for a magnetic layer coating liquid to form a magnetic layer coating liquid. Alternatively, it is possible to add slurry, which has been prepared with the aforementioned carbide, an abrasive and a solvent and dispersed in advance uniformly with a sand mill, ultrasonic dispersion device, to a magnetic layer coating liquid.

When coating a magnetic recording medium of multilayer configuration in the present invention, the use of a wet-on-dry method in which a coating liquid for forming a nonmagnetic layer is coated on the nonmagnetic support and dried to form a nonmagnetic layer, and then a coating liquid for forming a magnetic layer is coated on the nonmagnetic layer and dried. With this method, the thickness variation of the magnetic layer can be reduced to improve the S/N ratio. Therefore, this method is suitable for manufacturing a high-density magnetic recording medium.

When using a wet-on-wet method in which a coating liquid for forming a nonmagnetic layer is coated, and while this coating is still wet, a coating liquid for forming a magnetic layer is coated thereover and dried, the following methods are desirably employed;

(1) a method in which the nonmagnetic layer is first coated with a coating device commonly employed to coat magnetic coating materials such as a gravure coating, roll coating, blade coating, or extrusion coating device, and the magnetic layer is coated while the nonmagnetic layer is still wet by means of a support pressure extrusion coating device such as is disclosed in Japanese Examined Patent Publication (KOKOKU) Heisei No. 146186 and Japanese Unexamined Patent Publication (KOKAI) Showa No. 60-238179 and Japanese Unexamined Patent Publication (KOKAI) Heisei No. 2-265672;

(2) a method in which the upper and lower layers are coated nearly simultaneously by a single coating head having two built-in slits for passing coating liquid, such as is disclosed in Japanese Unexamined Patent Publication (KOKAI) Showa No. 63-88080, Japanese Unexamined Patent Publication (KOKAI) Heisei No. 2-17971, and Japanese Unexamined Patent Publication (KOKAI) Heisei No. 2-265672; and

(3) a method in which the upper and lower layers are coated nearly simultaneously using an extrusion coating apparatus with a backup roller as disclosed in Japanese Unexamined Patent Publication (KOKAI) Heisei No. 2-174965. To avoid deteriorating the electromagnetic characteristics or the like of the magnetic recording medium by aggregation of magnetic particles, shear is desirably imparted to the coating liquid in the coating head by a method such as disclosed in Japanese Unexamined Patent Publication (KOKAI) Showa No. 62-95174 or Japanese Unexamined Patent Publication (KOKAI) Heisei No. 1-236968. In addition, the viscosity of the coating liquid preferably satisfies the numerical range specified in Japanese Unexamined Patent Publication (KOKAI) Heisei No. 3-8471.

The magnetic recording medium that has been coated and dried as mentioned above is normally calendered. The calendering rolls employed may be in the form of heat-resistant plastic rolls, such as epoxy, polyimide, polyamide, and polyimidoamide rolls, or in the form of metal rolls. Processing with metal rolls is particularly desirable for magnetic recording media in which magnetic layers are provided on both sides. The processing temperature is preferably equal to or greater than 50° C., more preferably equal to or greater than 100° C. The linear pressure is preferably equal to or greater than 200 kg/cm, approximately 196 kN/m, more preferably equal to or greater than 300 kg/cm, approximately 294 kN/m.

[Physical Characteristics]

The coefficient of friction of the magnetic recording medium of the present invention relative to the head is preferably equal to or less than 0.5 and more preferably equal to or less than 0.3 at temperatures ranging from −10° C. to 40° C. and humidity ranging from 0 percent to 95 percent, the surface resistivity on the magnetic surface preferably ranges from 10⁴ to 10¹² ohm/sq, and the charge potential preferably ranges from −500 V to +500 V. The modulus of elasticity at 0.5 percent extension of the magnetic layer preferably ranges from 100 to 2,000 kg/mm², approximately 980 to 19,600 MPa, in each in-plane direction. The breaking strength preferably ranges from 10 to 70 kg/mm², approximately 98 to 686 MPa. The modulus of elasticity of the magnetic recording medium preferably ranges from 100 to 1,500 kg/mm², approximately 980 to 14,700 MPa, in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent. The glass transition temperature (i.e., the temperature at which the loss elastic modulus of dynamic viscoelasticity peaks as measured at 110 Hz) of the magnetic layer preferably ranges from 50 to 120° C., and that of the nonmagnetic layer preferably ranges from 0 to 100° C. The loss elastic modulus preferably falls within a range of 1×10³ to 8×10⁴ N/cm² and the loss tangent is preferably equal to or less than 0.2. Adhesion failure tends to occur when the loss tangent becomes excessively large. These thermal characteristics and mechanical characteristics are desirably nearly identical, varying by 10 percent or less, in each in-plane direction of the medium. The residual solvent contained in the magnetic layer is preferably equal to or less than 100 mg/m² and more preferably equal to or less than 10 mg/m². The void ratio in the coated layers, including both the nonmagnetic layer and the magnetic layer, is preferably equal to or less than 30 volume percent, more preferably equal to or less than 20 volume percent. Although a low void ratio is preferable for attaining high output, there are some cases in which it is better to ensure a certain level based on the object.

The center surface average surface roughness Ra of the magnetic layer measured with an optical interferotype surface roughness meter HD-2000 made by WYKO is preferably from 1.0 to 6.0 nm, more preferably equal to or less than 5.5 nm. The maximum height Rₘₐₓ of the magnetic layer is preferably equal to or less than 0.5 micrometer, the ten-point average surface roughness Rz is preferably equal to or less than 0.3 micrometer, the center surface peak height R_{P} is preferably equal to or less than 0.3 micrometer, the center surface valley depth R_{V} is preferably equal to or less than 0.3 micrometer, the center-surface surface area percentage Sr preferably ranges from 20 percent to 80 percent, and the average wavelength lambdaₐ preferably ranges from 5 to 300 micrometers. On the surface of the magnetic layer, it is possible to freely control the number of surface protrusions of 0.01 to 1 micrometer in size within a range from 0 to 2,000 per 0.1 mm² to optimize electromagnetic characteristics and the coefficient of friction. These can be readily achieved by controlling surface properties through the filler used in the support, by controlling the particle diameter and quantity of the powder added to the magnetic layer, and by controlling the roll surface configuration in calendar processing. Curling is preferably controlled to within ±3 mm.

In the magnetic recording medium of the present invention, it will be readily deduced that the physical properties of the nonmagnetic layer and magnetic layer may be varied based on the objective. For example, the modulus of elasticity of the magnetic layer may be increased to improve running durability while simultaneously employing a lower modulus of elasticity than that of the magnetic layer in the nonmagnetic layer to improve the head contact of the magnetic recording medium.

The magnetic recording medium of the present invention can achieve both reduced head abrasion and good durability, especially in magnetic recording and reproduction systems employing MR heads, by incorporating carbide having a mean particle diameter of 0.02 to 0.10 micrometer as an abrasive into a magnetic layer. That is, the magnetic recording medium of the present invention is suitable for use in recording magnetic signals thereon and reproducing the signals with an MR head.

### EXAMPLES

The present invention will be described in detail below based on examples. However, the present invention is not limited to the examples. Further, “parts” given in Examples are weight parts unless specifically stated otherwise.

### Example 1

The components of a magnetic layer coating liquid and those of a nonmagnetic layer coating liquid, described further below, were respectively kneaded in an open kneader. A dispersion medium in the form of zirconia beads 0.5 mm in diameter was added in suitable quantity to the coating liquids and the mixtures were dispersed in sand mills. Three parts of trifunctional low-molecular-weight polyisocyanate compound were added to the magnetic layer coating liquid dispersion obtained and five parts to the nonmagnetic layer coating liquid dispersion obtained. To each of these were then added 40 parts of cyclohexanone and the dispersions were filtered through filters having a 1 micrometer average pore diameter to prepare a magnetic layer coating liquid and a nonmagnetic layer coating liquid.

The nonmagnetic layer coating liquid obtained was coated and dried on a PEN support 6 micrometers in thickness with a centerline average surface roughness of 3 rn in a quantity yielding a nonmagnetic layer 1.5 micrometers in thickness following drying. Subsequently, the magnetic layer coating liquid was applied thereover in a quantity calculated to yield a magnetic layer 0.06 micrometer in thickness following drying. While still wet, the magnetic layer was oriented with a magnet having a magnetic force of 0.3 T and dried. Next, a backcoat layer coating liquid was applied and dried on the opposite surface of the support in a quantity calculated to yield a dry thickness of 0.5 micrometer. After drying, a seven-stage calender comprised entirely of metal rolls was used to treat the surface for smoothness at a rate of 90 m/min, a linear pressure of 300 kg/cm (294 kN/m), and a temperature of 90° C. The product was slit to a width of ½ inch, the slit product was fed out, the product was picked up by a device having a winding unit in a manner in which nonwoven cloth and a razor blade pressed against the magnetic surface, and the surface of the magnetic layer was cleaned with a tape cleaning unit to obtain tape samples.

(Magnetic layer coating liquid)

| | | |
|---|---|---|
| Hexagonal barium ferrite powder | 100 | parts |
| Plate diameter: 25 nm | | |
| Hc: 175 kA/m (2200 Oe) | | |
| Sigmaₛ: 50 A · m²/kg (50 emu/g) | | |
| Polyester polyurethane resin | 15 | parts |
| (UR8200 manufactured by Toyobo Co., Ltd., | | |
| containing sulfonate group) | | |
| SiC powder | 5 | parts |
| Mean particle diameter: 0.08 micrometer | | |
| Mohs' hardness: 9.3 (Vickers hardness = 2600) | | |
| Carbon black (mean particle diameter: | 0.5 | part |
| 0.04 micrometer) | | |
| Cyclohexanone | 100 | parts |
| Methyl ethyl ketone | 100 | parts |
| Butyl stearate | 1 | part |
| Stearic acid | 2 | parts |

(Nonmagnetic layer coating liquid)

| | | |
|---|---|---|
| Alpha-Fe₂O₃ | 80 | parts |
| Mean major axis length: 0.15 micrometer | | |
| Mean acicular ratio: 7 | | |
| Specific surface area by BET method: 50 m²/g | | |
| Carbon black | 20 | parts |
| Mean particle diameter: 20 nm | | |
| Vinyl chloride copolymer | 13 | parts |
| (MR110 manufactured by Nippon Zeon Co., Ltd.) | | |
| Polyester polyurethane resin | 6 | parts |
| (UR8200 manufactured by Toyobo Co., Ltd., | | |
| containing sulfonate group) | | |
| Phenylphosphonic acid | 5 | parts |
| Cyclohexanone | 150 | parts |
| Methyl ethyl ketone | 150 | parts |
| Butyl stearate | 2 | parts |
| Stearic acid | 1 | part |

(Backcoat layer coating liquid)

| | | |
|---|---|---|
| Microparticulate carbon black | 100 | parts |
| (BP-800 manufactured by Cabot Corporation, | | |
| mean particle diameter: 0.02 micrometer) | | |
| Coarse particulate carbon black | 10 | parts |
| Mean particle diameter: 0.1 micrometer) | | |
| Alpha-Fe₂O₃ | 15 | parts |
| Mean major axis length: 0.10 micrometer | | |
| Nitrocellulose resin | 100 | parts |
| Polyurethane resin | 30 | parts |
| (N2301 manufactured by Nippon Polyurethane | | |
| Co., Ltd.) | | |

Dispersant

| | | |
|---|---|---|
| Copper oleate | 5 | parts |
| Copper phthalocyanine | 5 | parts |
| Precipitated barium sulfate | 5 | parts |
| Methyl ethyl ketone | 2500 | parts |
| Butyl acetate | 300 | parts |
| Toluene | 500 | parts |

### Example 2

With the exception that the thickness of the magnetic layer was changed to 0.04 micrometer and the abrasive contained in the magnetic layer was changed to SiC powder having a mean particle diameter of 0.05 micrometer, a magnetic tape was obtained by the same manufacturing method as in Example 1.

### Example 3

With the exception that the thickness of the magnetic layer was changed to 0.03 micrometer and the abrasive contained in the magnetic layer was changed to SiC powder having a mean particle diameter of 0.03 micrometer, a magnetic tape was obtained by the same manufacturing method as in Example 1.

### Example 4

With the exception that the abrasive contained in the magnetic layer was changed to WC powder with a mean particle diameter of 0.05 micrometer (Mohs' hardness 9⁺ (Vickers hardness 2500)), a magnetic tape was obtained by the same manufacturing method as in Example 1.

### Example 5

With the exception that the abrasive contained in the magnetic layer was changed to ZrC powder with a mean particle diameter of 0.05 micrometer (Mohs' hardness 9⁺ (Vickers hardness 2600)), a magnetic tape was obtained by the same manufacturing method as in Example 1.

### Example 6

With the exception that the abrasive contained in the magnetic layer was changed to VC powder with a mean particle diameter of 0.05 micrometer (Mohs' hardness 9⁺ (Vickers hardness 2900)), a magnetic tape was obtained by the same manufacturing method as in Example 1.

### Example 7

With the exception that the abrasive contained in the magnetic layer was changed to TiC powder with a mean particle diameter of 0.05 micrometer (Mohs' hardness 9⁺ (Vickers hardness 2800)), a magnetic tape was obtained by the same manufacturing method as in Example 1.

### Example 8

With the exception that the abrasive contained in the magnetic layer was changed to B₄C powder with a mean particle diameter of 0.08 micrometer (Mohs' hardness 9.6 (Vickers hardness 4000)), a magnetic tape was obtained by the same manufacturing method as in Example 1.

### Example 9

With the exception that the hexagonal barium ferrite powder was changed to acicular metal powder with a mean particle diameter of 45 nm, an Hc of 191 kA/m (2,400 Oe), and a sigmaₛ of 110 A·m²/kg (110 emu/g), and the abrasive contained in the magnetic layer was replaced with SiC powder with a mean particle diameter of 0.08 micrometer, a magnetic tape was obtained by the same manufacturing method as in Example 1.

### Comparative Example 1

With the exception that the abrasive contained in the magnetic layer was changed to alpha-Al₂O₃ powder with a mean particle diameter of 0.08 micrometer (Mohs' hardness 9 (Vickers hardness 2100)), a magnetic tape was obtained by the same manufacturing method as in Example 1.

### Comparative Example 2

With the exception that the abrasive contained in the magnetic layer was changed to diamond powder with a mean particle diameter of 0.08 micrometer (Mohs' hardness 10 (Vickers hardness 8000)), a magnetic tape was obtained by the same manufacturing method as in Example 1.

### Comparative Example 3

With the exception that the thickness of the magnetic layer was changed to 0.04 micrometer and the abrasive contained in the magnetic layer was changed to diamond powder with a mean particle diameter of 0.05 micrometer, a magnetic tape was obtained by the same manufacturing method as in Example 1.

### Comparative Example 4

With the exception that the thickness of the magnetic layer in Example 1 was changed to 0.03 micrometer and the abrasive contained in the magnetic layer was changed to diamond powder with a mean particle diameter of 0.03 micrometer, a magnetic tape was obtained by the same manufacturing method as in Example 1.

### Comparative Example 5

With the exception that the hexagonal barium ferrite powder was changed to acicular metal powder with a mean particle diameter of 45 nm, an Hc of 191 kA/m (2,400 Oe), and a sigmaₛ of 110 A·m²/kg (110 emu/g), and the abrasive contained in the magnetic layer was replaced with diamond powder with a mean particle diameter of 0.08 micrometer, a magnetic tape was obtained by the same manufacturing method as in Example 1.

### Comparative Example 6

With the exception that the abrasive contained in the magnetic layer was changed to SiC powder having a mean particle diameter of 0.01 micrometer, a magnetic tape was obtained by the same manufacturing method as in Example 1.

### Comparative Example 7

With the exception that the abrasive contained in the magnetic layer was changed to SiC powder having a mean particle diameter of 0.12 micrometer, a magnetic tape was obtained by the same manufacturing method as in Example 1.

(Measurement Methods)

(1) Method of Evaluating Abrasion Width

In an environment of 23° C. and 50 percent RH, with the surface of the magnetic layer of the magnetic tape in a state of contact at a lap angle of 12° with the edge of a Sendust or AlTiC square member (a square member 2 cm in length having a square cross section measuring 0.5 cm on a side), a 200 m length of magnetic tape was run back and forth 50 times with a tension of 100 g at a rate of 3 m/s, after which the abrasion width of the edge was observed and measured from above the edge using an optical microscope to obtain abrasion widths Ws and Wa.

(2) Method of Evaluating Abrasion of MR Heads

An MR head was mounted on a linear tester and the difference between the initial height of the MR head and the height of the MR head after running for 100 hours in an environment of 23° C. and 50 percent RH was measured. The amount of abrasion of the MR head was measured as a relative value; 1 or less was considered a good value.

(3) Method of Evaluating Durability

To evaluate the durability of the magnetic tape, the surface of the magnetic tape at the conclusion of the above-described AlTiC abrasion width measurement was observed with an optical microscope. The absence of scratching was denoted by ◯, the appearance of some scratching but no separation of the coating was denoted by Δ, and the appearance of separation of the coating itself was denoted by X. An evaluation of ◯ or Δ was considered adequate durability for practical use.

TABLE 1

| | | Magnetic | Abrasive | | | | | Head | |
|---|---|---|---|---|---|---|---|---|---|
| | | layer | | Particle | Abrasion width | | | abrasion | |
| | Ferromagnetic | thickness | | diameter | Ws | Wa | Ratio | (relative | |
| | powder | (μm) | Powder | (μm) | (μm) | (μm) | Ws/Wa | value) | Durability |
| Example 1 | BaFe | 0.06 | SiC | 0.08 | 40 | 3 | 13.3 | 0.8 | ◯ |
| Example 2 | BaFe | 0.04 | SiC | 0.05 | 38 | 2 | 19.0 | 1 | ◯ |
| Example 3 | BaFe | 0.03 | SiC | 0.03 | 35 | 2 | 17.5 | 0.9 | Δ |
| Example 4 | BaFe | 0.06 | WC | 0.05 | 50 | 4 | 12.5 | 1 | ◯ |
| Example 5 | BaFe | 0.06 | ZrC | 0.05 | 40 | 4 | 10.0 | 0.8 | ◯ |
| Example 6 | BaFe | 0.06 | VC | 0.05 | 45 | 3 | 15.0 | 0.6 | ◯ |
| Example 7 | BaFe | 0.06 | TiC | 0.05 | 50 | 5 | 10.0 | 0.8 | ◯ |
| Example 8 | BaFe | 0.06 | B₄C | 0.08 | 55 | 4 | 13.8 | 1 | ◯ |
| Example 9 | MP | 0.06 | SiC | 0.08 | 40 | 3 | 13.3 | 1 | ◯ |
| Comp. Ex. 1 | BaFe | 0.06 | α-Al₂O₃ | 0.08 | 40 | 5 | 8.0 | 0.8 | X |
| Comp. Ex. 2 | BaFe | 0.06 | Diamond | 0.08 | 45 | 40 | 1.1 | 10 | ◯ |
| Cdmp. Ex. 3 | BaFe | 0.04 | Diamond | 0.05 | 50 | 38 | 1.3 | 9 | ◯ |
| Comp. Ex. 4 | BaFe | 0.03 | Diamond | 0.03 | 50 | 42 | 1.2 | 12 | Δ |
| Comp. Ex. 5 | MP | 0.06 | Diamond | 0.08 | 40 | 50 | 0.8 | 13 | ◯ |
| Cdmp. Ex. 6 | BaFe | 0.06 | SiC | 0.01 | 16 | 1 | 16.0 | 1 | X |
| Comp. Ex. 7 | BaFe | 0.06 | SiC | 0.12 | 50 | 10 | 5.0 | 5 | ◯ |

BaFe: Barium ferrite,
MP: Metal Powder

Evaluation Results

As shown in Table 1, the magnetic tapes of Examples 1 to 9 in which carbide having a mean particle diameter within a range of 0.02 to 0.10 micrometer was employed as an abrasive in the magnetic layer had good head abrasion and durability.

By contrast, the magnetic tape of Comparative Example 1 in which alpha-Al₂O₃ was employed as an abrasive in the magnetic layer had poor durability despite little head abrasion.

The magnetic tapes of Comparative Examples 2 to 5 in which diamond was employed as an abrasive in the magnetic layer, although exhibiting no practical problem with durability, produced marked head abrasion. This was thought to have occurred because the diamond had excessive capacity to abrade AlTiC constituting the MR head.

The magnetic tapes of Comparative Examples 6 and 7 in which carbide (SiC) with a particle diameter falling outside the range of 0.02 to 0.10 micrometer was employed as an abrasive in the magnetic layer did not achieve both head abrasion and durability.

There was also a large difference in head abrasion even for equivalent Sendust abrasion widths, as will be apparent from a comparison of Example 6 and Comparative Example 2, for example. This indicates that the amount of Sendust abrasion did not correspond to the head abrasion in an MR head.

The magnetic recording medium of the present invention is suited to magnetic recording and reproduction systems using MR reproduction heads.

What is claimed is:

1. A magnetic recording medium comprising a nonmagnetic layer comprising a nonmagnetic powder and a binder and a magnetic layer comprising a ferromagnetic powder, a binder and an abrasive in this order on a nonmagnetic support, wherein
said abrasive comprises carbide having a mean particle diameter ranging from 0.02 to 0.10 micrometer.

2. The magnetic recording medium according to claim 1, wherein said magnetic layer comprises said carbide in an amount of 0.5 to 15 weight parts per 100 parts of the ferromagnetic powder.

3. The magnetic recording medium according to claim 1, wherein Sendust abrasion width Ws of said magnetic layer ranges from 20 to 60 micrometers and a ratio (Ws/Wa) of Sendust abrasion width Ws to AlTiC abrasion width Wa of said magnetic layer is equal to or higher than 10.

4. The magnetic recording medium according to claim 3, wherein the ratio (Ws/Wa) of Sendust abrasion width Ws to AlTiC abrasion width Wa of said magnetic layer ranges from 10 to 100.

5. The magnetic recording medium according to claim 3, wherein the ratio (Ws/Wa) of Sendust abrasion width Ws to AlTiC abrasion width Wa of said magnetic layer ranges from 10 to 60.

6. The magnetic recording medium according to claim 3, wherein the Sendust abrasion width Ws of said magnetic layer ranges from 20 to 50 micrometers.

7. The magnetic recording medium according to claim 1, wherein said carbide has a Mohs' hardness of equal to or higher than 8 but less than 10.

8. The magnetic recording medium according to claim 1, wherein said carbide has a Mohs' hardness of equal to or higher than 9 but less than 10.

9. The magnetic recording medium according to claim 1, wherein said carbide is at least one selected from the group consisting of TiC, SiC, ZrC, B₄C, WC and VC.

10. The magnetic recording medium according to claim 1, wherein said carbide is at least one selected from the group consisting of TiC, SiC and B₄C

11. The magnetic recording medium according to claim 1, wherein said magnetic layer has a thickness ranging from 0.03 to 0.10 micrometer.

12. The magnetic recording medium according to claim 1, wherein said ferromagnetic layer is a ferromagnetic metal powder having a mean major axis length ranging from 30 to 50 nm or a hexagonal ferrite powder having a mean plate diameter ranging from 10 to 40 nm.

13. A method of recording a magnetic signal on the magnetic recording medium according to claim 1 with a recording head and reproducing the magnetic signal with a magnetoresistive head.

14. An apparatus comprising a recording head, a magnetoresistive reproduction head and the magnetic recording medium according to claim 1.
